(19) United States
(12) Patent Application Publication
(10) Pub. No.: US 2024/0419815 A1
(43) Pub. Date: Dec. 19, 2024

(54) PORTABLE ENCRYPTION DEVICE

(71) Applicant: iStorage Limited, Middlesex (GB)

(72) Inventors: John MICHAEL, London (GB); Quan XU, Middlesex (GB)

(21) Appl. No.: 18/702,707

(22) PCT Filed: Oct. 17, 2022
(86) PCT No.: PCT/GB2022/052643

§ 371 Date: Apr. 18, 2024

(30) Foreign Application Priority Data
Oct. 19, 2021 (GB) 2114925.7

(51) Int. Cl. G06F 21/60; H04L 9/08

(52) U.S. Cl. CPC G06F 21/602; H04L 9/0822

(57) ABSTRACT

A portable encryption device (100) is provided comprising: a controller (103) having a plurality of modes; an internal memory (104) for storing a plurality of encryption keys; a battery (B); an input device (101) connected to the controller and for selecting between the plurality of modes; and a connector (105) for connecting the portable encryption device to a computer (200). The battery (B) is arranged to selectively provide electrical power to the controller and input device such that the plurality of modes are user-selectable while the device is not connected to a computer. In a first mode of the plurality of modes, the controller (103) is configured to encrypt and decrypt data using a first encryption algorithm and, in a second mode of the plurality of modes, the controller (103) is configured to encrypt and decrypt data using a second encryption algorithm, different from the first encryption algorithm. A method is also provided.

The present disclosure relates to a portable encryption device and a method of using the portable encryption device.

Portable encryption devices, which may or may not incorporate internal data storage, have been widely used for securing user data. One example of such portable data encryption device is the secure flash drive, such as iStorage datAshur PRO². When data is transferred from a host computer to datAshur PRO², it is encrypted on-the-fly by crypto hardware of the device. Likewise, the data will be decrypted on-the-fly when it is transferred from datAshur PRO² to the host computer. Another example of such portable data encryption device may be an encryption module without internal data storage, such as the iStorage cloudAshur. The cloudAshur can perform real-time encryption of cleartext data and real-time decryption on ciphertext received from a computer. After encrypting/decrypting the data, as appropriate, the cloudAshur returns the data to the host computer.

According to a first aspect, there is provided portable encryption device comprising: a controller having a plurality of modes; an encryption engine connected to or implemented within the controller; an internal memory for storing a plurality of encryption keys; a battery; an input device connected to the controller and for selecting between the plurality of modes; and a connector for connecting the portable encryption device to a computer; wherein the battery is arranged to selectively provide electrical power to the controller and input device such that the plurality of modes are user-selectable while the device is not connected to a computer; wherein, in a first mode of the plurality of modes, the encryption engine is configured to encrypt and decrypt data using a first encryption algorithm; and wherein, in a second mode of the plurality of modes, the encryption engine is configured to encrypt and decrypt data using a second encryption algorithm, different from the first encryption algorithm.

The device may therefore encrypt data using a variety of different encryption algorithms, where the user can select which algorithm is desired for use. Different algorithms may have different levels of complexity or security and so being able to select a desired encryption algorithm may allow the user to control how secure encrypted data is (vs, potentially a trade-off in the time taken to encrypt/decrypt data using a given algorithm).

The plurality of modes may comprise a third mode, wherein in the third mode, the controller is configured to encrypt and decrypt data using a third encryption algorithm, different from each of the first and second algorithms.

Encryption algorithms include, but are not limited to: Advanced Encryption Standard (AES), Data Encryption Standard (DES), Triple DES (TDES), Extension of DES (DESX), Rivest Shamir Adleman (RSA), Elliptic Curve Cryptography (ECC) among others. Several of these algorithms have various algorithm “modes”, which are essentially different algorithms based on the base algorithm. For example, the AES algorithm may be operated in one of the following algorithm modes: Electronic Code Book (ECB), Cipher Block Chaining (CBC), Cipher FeedBack (CFB), Output FeedBack (OFB), Counter (CTR), XEX Tweakable Block Cipher with Ciphertext Stealing (XTS) etc. In the AES-ECB mode, the data to be encrypted is divided into equal sized blocks and each block is encrypted individually using the AES algorithm. In the AES-CBC, the data is again divided into equal-sized blocks, but each block of plaintext is XORed with the previous ciphertext block before being encrypted. This means that two identical blocks of plaintext in a given message will produce different blocks of ciphertext from one another.

Each algorithm mode (e.g. EDB, CBC, OFB etc.) within a given algorithm (e.g. AES) may therefore be considered to be its own algorithm.

Thus, in some embodiments each encryption algorithm may be an algorithm selected from a group comprising: AES, DES, RSA, ECC, ECB, CBC, CTR, CFB, XTS, and GCM encryption algorithms, and their respective algorithm modes.

A plurality of encryption keys may be stored on the internal memory, wherein each encryption key is associated with at least one of the modes. The encryption keys may be stored in encrypted form on the internal memory. The controller may be configured to receive authentication information via the input device and to calculate a derived encryption key from the received authentication information. The controller may be further configured to decrypt at least one encryption key stored on the internal memory using the derived encryption key and to provide the decrypted encryption key to the encryption engine. The authentication information may be a PIN, a password, or biometric information, for example.

Having multiple encryption keys, along with multiple encryption modes, may increase the security of data encrypted with the device. In the ideal scenario, an attacker does not know either the encryption key that was used nor even what encryption method was used. This lack of knowledge of what encryption method was used therefore increases the search-space that an attacker needs to search when trying to decrypt intercepted data. It is difficult to work out from cipher data alone which method was used to encrypt the data.

At least one encryption key may be associated with at least two modes out of the plurality of modes.

The device may further comprise a second connector for connecting to an external storage device, wherein the portable encryption device is configured to encrypt data received via the connector, based on the selected mode, and wherein the device is configured to pass the encrypted data to the second connector.

In this manner, the device may function as a bridge between the computer and the external storage device. When data is received from the computer, the device may encrypt it according to the selected method, and using an encryption key, and store that data on the external storage device. Similarly, then data is being retrieved from the external storage device, by the computer, the device may decrypt the data. Of course, it is essential that the device is set to use the same encryption algorithm when decrypting the data as was used when originally encrypting the data. It is also, separately, essential that the device uses the same key or a corresponding decryption key when decrypting the data as was used for originally encrypting the data.

Alternatively, the device may further comprise a second internal memory, wherein the portable encryption device is configured to encrypt data received via the connector, based on the selected mode, and wherein the device is configured to store the encrypted data on the second internal memory.

In this way, the device may securely store user data, in encrypted form. This data may then be transported, along with the device, to a second computer. Then, using the same encryption algorithm and an appropriate encryption key, the device can provide the decrypted data to the second computer.

The controller may be configured to receive authentication information via the input device and to calculate a derived encryption key from the received authentication information; and to decrypt at least one encryption key stored on the internal memory using the derived encryption key and to provide the decrypted encryption key to the encryption engine. This may improve the security of the encryption key(s) stored on the device.

The input device may comprise a keypad, a button, or a touchscreen.

These may provide easy ways for the user to interact with the device, e.g. to select a desired mode and, where applicable, to provide authentication information.

In another aspect, there is provided a system comprising a computer and the portable encryption device of the first aspect. In this aspect, the connector of the portable memory storage device is connected to the computer.

The system may further comprise an external storage device, wherein the portable encryption device is connected to the external storage device.

In a further aspect, there is provided a method of encrypting data using the portable encryption device of the first aspect. The method comprises: selecting, by a user, one mode out of the plurality of modes; receiving, at the portable encryption device, data from a computer or from an external storage device; and encrypting the received data based on the selected mode.

The method may comprise a step of either storing the encrypted data in the portable encryption device, or passing the encrypted data to one of a computer and an external storage device for storage.

The method may further comprise the steps of: receiving authentication information via the input device; the controller calculating a derived encryption key from the received authentication information; and the controller decrypting at least one encryption key stored on the internal memory using the derived encryption key and providing the decrypted encryption key to the encryption engine.

In this manner, the encryption keys are stored on the internal memory in encrypted form. The key for decrypting one or more of the encryption keys (i.e. the derived encryption key) is not itself stored on the internal memory. Rather, the key for decrypting these is determined from (calculated from) the authentication information that is input by the user. This improves the security of the encrypted encryption keys stored on the device.

Certain embodiments of the present disclosure will now be described in greater detail by way of example only and with reference to the accompanying drawings in which:

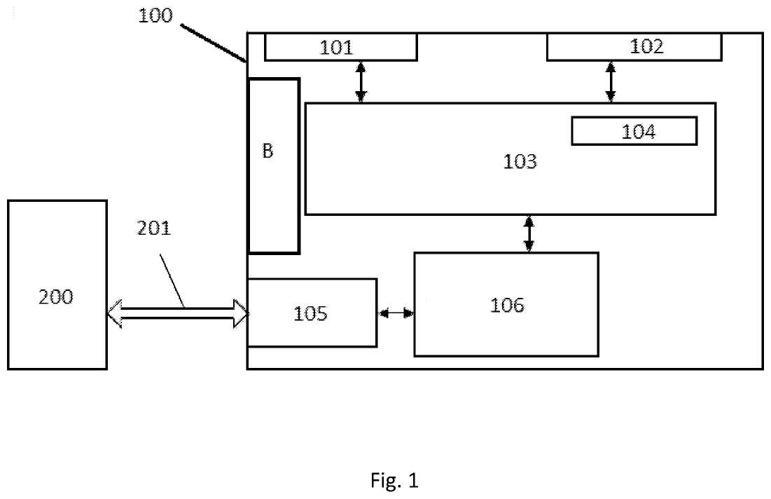

FIG. 1 shows a schematic of a portable encryption device connected to a computer;

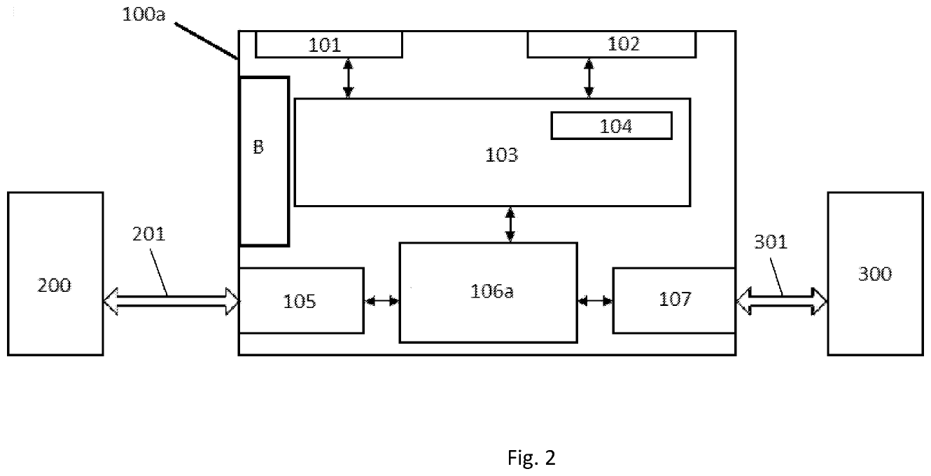

FIG. 2 shows a schematic of a portable encryption device connected to a computer and to an external storage device;

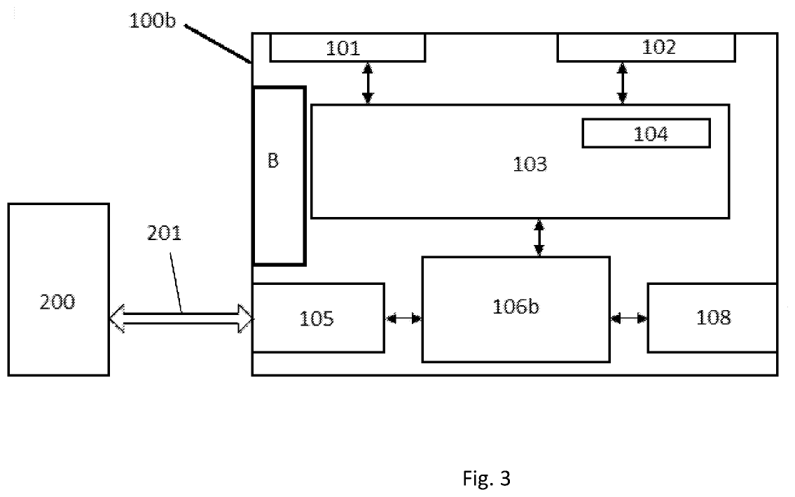

FIG. 3 shows a schematic of a portable encryption device having an internal memory and connected to a computer;

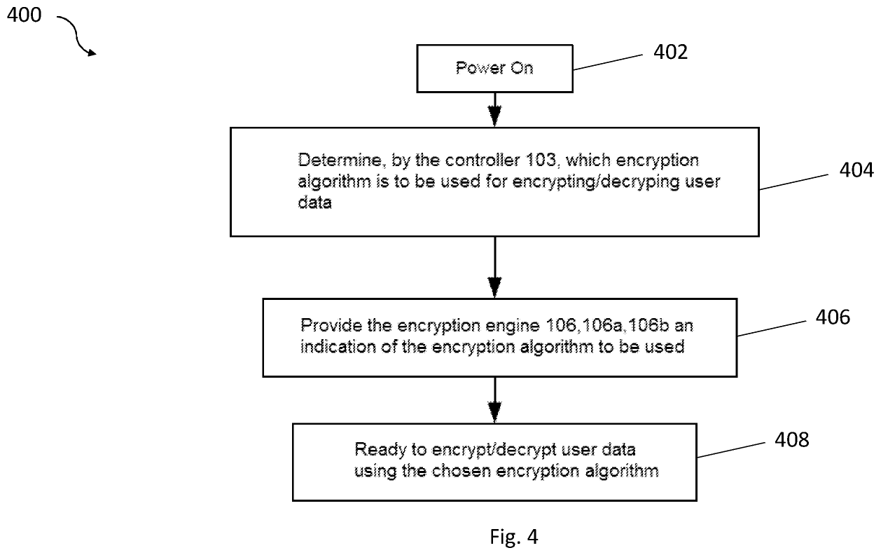

FIG. 4 shows a method of starting up the device;

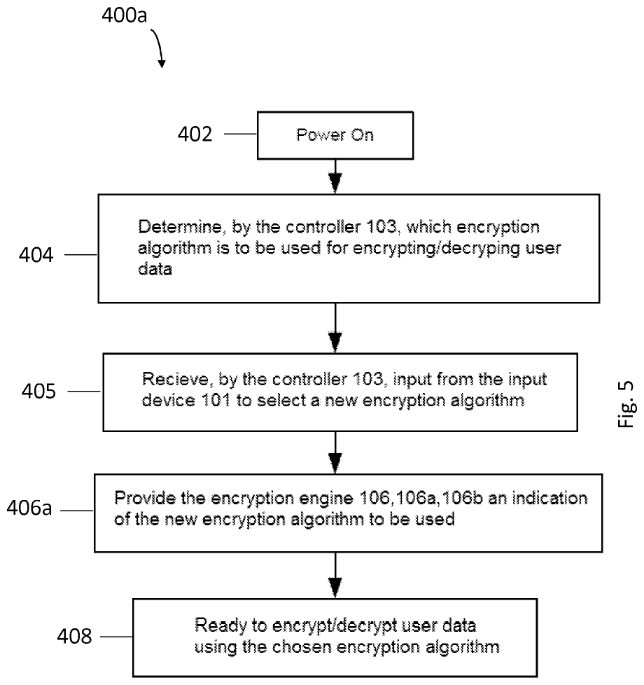

FIG. 5 shows an alternative method of starting up the device; and

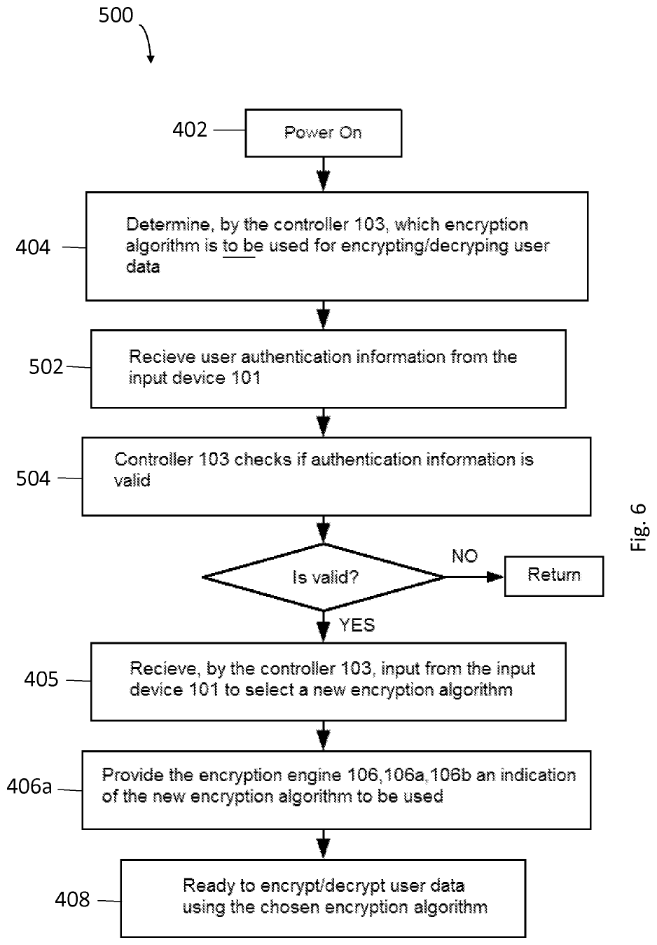

FIG. 6 shows another alternative method of starting up the device, using user authentication information.

FIG. 1 shows a portable encryption device 100 that is removably connected to a computer 200.

The portable encryption device 100 comprises an input device 101 for receiving an input from a user. The input device may, for example, be a keypad, a touchscreen, or a button.

The device 100 may comprise a display module 102 for communication information to a user. For example, the display module 102 may be as simple as an LED indicating the device is powered on, or the display module 102 may be more complex and consist of an LCD screen for displaying data.

The device 100 comprises a battery B for providing power, allowing at least some functions of the device 100 to be performed when the device 100 is not connected to a computer or external storage device.

The device 100 further comprises a controller 103 that contains or is connected to a memory 104. The memory 104 is solely used for storing one or more data encryption keys (optionally in encrypted form) and may store implementation codes for a plurality of encryption methods, and any other data necessary for operating the device 100. For security, it is preferable that the data encryption keys are stored in encrypted form and not stored in plaintext in the memory 104. The memory 104 is not used for storing data that is encrypted/decrypted by the device 100, e.g. data that has been received from either a computer or an external storage device connected to the device 100. In a preferred case, the device 100 is configured such that data stored on the memory 104 is never transferred external to the device (e.g. the data thereon is never transferred to a computer or external storage device to which the device 100 is connected). The controller 103 is for receiving input from the input device 101, for controlling the display module 102, if present, and for controlling an encryption engine 106 and a connector 105.

In use, the portable encryption device 100 is connected to a computer 200, as shown. The device is configured to communicate, over a communication bus 201, with a computer 200 that the device 100 is removably connected to. The device 100 connects to the computer via the connector 105 of the device 100. The connector 105 may be any of: a USB connector, a FireWire connector, a SATA interface, an eMMC interface, an SD/TF card interface, an NVMe/PCle interface etc.

The encryption engine 106 is arranged to receive data from the computer 200 via the connector 105 and to either encrypt the received data or decrypt the received data, based on commands received from the controller 103. The encryption engine 106 may be implemented in the controller 103, or the encryption engine 106 may be a separate component within the device 100.

In the device 100 shown in FIG. 1, the (encrypted or decrypted) data is returned to the computer 200 via the connector 105.

The device 100a shown in FIG. 2 is similar in several respects to the device 100 of FIG. 1. Where the device 100a of FIG. 2 has the same components as in the device 100 of FIG. 1, like reference numerals will be used.

That is, the device 100a of FIG. 2 comprises an input module 101, a controller 103, a memory 104, a battery B, and a connector 105. The device 100a may further comprise a display 102.

The device 100a further comprises an encryption engine 106a. The encryption engine 106a is configured to receive data from a computer 200, via the connector 105, and to encrypt/decrypt the received data based on commands from the controller 103. The encryption engine 106a then passes the encrypted/decrypted data on to a second connector 107. The data is then transmitted over a second communication bus 301 to an external storage device 300. The external storage device 300 may be any suitable device, including a hard drive, solid state drive, flash drive, etc.

Typically, the encryption engine 106a may be arranged to encrypt any data received from the (first) connector 105 and pass the encrypted data on to the external storage device via the second connector 107. Similarly, the encryption engine 106a may be arranged to decrypt any data received via the second connector 107, and then pass that decrypted data on to the computer 200 via the (first) connector 105. In this manner, all data that is stored on the external storage device 300 will be stored in encrypted form.

The second connector 107 may be any of: a USB connector, a FireWire connector, a SATA interface, an eMMC interface, an SD/TF card interface, an NVMe/PCle interface etc. The second connector 107 may be the same type of connector as the (first) connector 105, or may be different.

The encryption engine 106a may be implemented in the controller 103, or the encryption engine 106a may be a separate component within the device 100a.

The device 100b shown in FIG. 3 is similar to the device 100a shown in FIG. 2 and where components are the same, like reference numerals will be used.

That is, the device 100b of FIG. 3 comprises an input module 101, a controller 103, a memory 104, a battery B, and a connector 105. The device 100b may further comprise a display 102.

The device 100b further comprises an encryption engine 106b and a second internal memory 108. The second internal memory 108 is at least logically separate from the memory 104 and the second internal memory 108 may be a physically separate component, separate from the memory 104. Unlike memory 104, the second internal memory does store data received from a computer 200 that has been encrypted/decrypted by the device 100b. The second internal memory 108 can be implemented as any of EEPROM, flash memory, a hard disk drive, a solid state drive or any other suitable form of computer memory.

The encryption engine 106b is configured to receive data from a computer 200, via the connector 105, and to encrypt the received data based on commands from the controller 103. The encryption engine 106a then passes the encrypted data to the second internal memory 108 for storage thereon. When the computer 200 requests data from the device 100b that is stored in the second internal memory 104, the encryption engine 106b retrieves data from the second internal memory 108, decrypts the data, and passes the decrypted data on to the computer 200 via the connector 105.

In this manner, all data that is stored on the second internal memory 108 is stored in an encrypted form.

The encryption engine 106b may be implemented in the controller 103, or the encryption engine 106b may be a separate component within the device 100a.

There exist a variety of encryption algorithms used for encrypting data. Examples include Advanced Encryption Standard (AES), Data Encryption Standard (DES), Triple DES (TDES), Extension of DES (DESX), Rivest Shamir Adleman (RSA), Elliptic Curve Cryptography (ECC) among others. Many algorithms have a variety of different modes. For example, the AES algorithm may be operated in one of the following modes: Electronic Code Book (ECB), Cipher Block Chaining (CBC), Cipher FeedBack (CFB), Output FeedBack (OFB), Counter (CTR), XEX Tweakable Block Cipher with Ciphertext Stealing (XTS) etc. Each mode (e.g. CBC, OFB etc.) within a given algorithm (e.g. AES) may be considered to be its own algorithm.

The conversion of cleartext data (i.e. unencrypted data) into ciphertext data (i.e. encrypted data), is performed using a given encryption algorithm and using a given encryption key.

In order to decrypt data, it is necessary to know both the original encryption algorithm and a suitable decryption key. The decryption key may be identical to the original encryption key, e.g. in the case of symmetric encryption methods. Alternatively, the decryption key may be different from the original encryption key, e.g. in the case of asymmetric encryption methods such as public/private key cryptographic methods, among others.

If a person has some ciphertext and has a suitable decryption key, but attempts to decrypt the data using a different encryption algorithm from the algorithm originally used to encrypt that data, then the decryption attempt will fail.

For example, say a given piece of data has been encrypted using an encryption key, X, using the AES-CBC algorithm. In order to decrypt that data, the user must use encryption key X, in the AES-CBC algorithm. If the user tries to decrypt that data using the encryption key X, in the AES-OFB algorithm, then the decryption attempt will fail.

The device 100, 100a, 100b is capable of utilizing a number of different encryption algorithms. The different encryption algorithms may be implemented in the device 100, 100a, 100b as software (e.g. code stored in the memory 104), programmed firmware, or as distinct hardware units.

For example, the device may store the following algorithms: AES-CBC, AES-OFB, DES, TDES, and RSA.

A user may select, via the input device 101, a desired encryption algorithm for the encryption module 106, 106a, 106b to use when encrypting/decrypting data during use of the device.

After a given encryption algorithm has been selected, the controller 103 provides appropriate information to the encryption module 106, 106a, 106b and the encryption module 106, 106a, 106b will then encrypt and decrypt data, as appropriate, using that encryption algorithm.

The memory 104 also stores at least one encryption key. The encryption key is also provided to the encryption module 106, 106a, 106b for use in the selected encryption algorithm. Some algorithms may use the same encryption key. For example, the same encryption key could be used, in a given device 100, 100a, 100b, with both the AES-CBC and AES-OFB encryption algorithms.

The user may select the desired encryption algorithm before the device 100, 100a, 100b is connected to another device (e.g. computer 200 and/or external storage device 300). In this case, the controller 103 and other components, as required, are powered by the battery B, while the user selects the desired algorithm.

In some embodiments, the device 100, 100a, 100b requires the user to choose the desired encryption algorithm every time the device is powered on or plugged in to another device (e.g. computer 200 and/or external storage device 300). In other embodiments, the device 100, 100a, 100b will store a record of the last-selected encryption algorithm in the memory 104 and, when powered on/plugged in again, the device will default to the last-selected method. In this case, the user can still change the encryption algorithm, e.g. by selecting appropriate options via the input device 101.

FIG. 4 shows a method 400 of the basic start-up process for the device 100, 100a, 100b. The method begins at step 402 with the device being powered on. The power may be provided by the battery B or may be received from the computer 200 via the connector 105.

At step 404, the controller 103 determines which encryption algorithm is to be used.

This determination may be based on what the last-selected encryption algorithm was, or the controller 103 may instead default to a predetermined encryption algorithm.

At step 406, the controller 103 provides information to the encryption module 106, 106a, 106b indicating what encryption algorithm it should use to encrypt or decrypt data. At step 408, the device 100, 100a, 100b is ready to encrypt data using the chosen encryption algorithm.

FIG. 5 shows an alternative start-up process 400a for the device. The process is similar to the process shown in FIG. 4, but with an additional step and a corresponding amendment to the subsequent step. Steps 402, 404, and 408 in FIG. 5 are the same as shown in FIG. 4 and described above.

In the process of FIG. 5, after the controller 103 has determined which encryption algorithm is to be used (i.e. after step 404) the controller 103 waits for input to be received by the input device 101. In embodiments having a display 102, the controller 103 may indicate which encryption algorithm has been determined for use. This may, for example, be an indication of the last-used encryption algorithm or an indication of a default algorithm.

At step 405, the controller 103 receives input from the user, via the input device 101, instructing the device to use a new or different encryption algorithm. Of course, the user may manually select, via the user input device 101, to use the default or last-selected encryption algorithm, if so desired.

At step 406a, the controller 103 provides information to the encryption module 106, 106a, 106b indicating that the new encryption algorithm should be used to encrypt or decrypt data.

Then, as before, at step 408, the device 100, 100a, 100b is ready to encrypt data using the chosen encryption algorithm.

In some embodiments, the devices 100, 100a, 100b may implement a user authentication module in the controller 103. A user authentication module requires a user to input user authentication information before some or all functions of the device 100, 100a, 100b, are made available to the user. The user identification is validated by the controller 103, based on information previously stored in the memory 104, i.e. information relating to different users registered on the device 100, 100a, 100b.

User authentication information may be, for example, a password or PIN, input via the input device. User authentication information may also be biometric information, such as a fingerprint or iris scan. In such examples, the input device 101 will further comprise a suitable biometric scanner. The controller 103 may be configured to derive an encryption key from the authentication information, and to use this derived encryption key to encrypt the encryption key(s) stored in the memory 104. The encrypted encryption keys may then be stored in the memory 104 and may be accessed again (and decrypted) at a later time by the user providing the correct authentication information.

In this way, different users may have different user identities stored on the device 100, 100a, 100b. Alternatively or additionally, a single user may have multiple different user identities stored on the device 100, 100a, 100b. Each user identity may have an associated encryption key.

The device 100, 100a, 100b may require a user to be properly authenticated, e.g. by providing valid user identification information, before the user is allowed to select an encryption algorithm or before the device will perform encryption/decryption of data using the encryption module 106, 106a, 106b.

FIG. 6 shows a method 500 of the start-up process for the device, in embodiments having an authentication module. Several steps are the same as described above in relation to FIG. 5 and where steps are the same, like reference numerals will be used.

The method 500 begins at step 402 with the device 100, 100a, 100b being powered on.

At step 404, the controller 103 determines which encryption algorithm is to be used. This determination may be based on what the last-selected encryption algorithm was, or the controller 103 may instead default to a predetermined encryption algorithm.

At step 502, the controller 103 receives user authentication information from user via the input device 101.

At step 504, the controller 103 checks whether the authentication information is valid.

If the authentication information is determined not to be valid, the method 500 ends.

If the authentication information is determined to be valid, the method continues with step 405 where the controller 103 receives input from the user, via the input device 101, instructing the device to use a new or different encryption algorithm. Of course, the user may manually select, via the user input device 101, to use the default or last-selected encryption algorithm, if so desired. Step 405 optionally further comprises the controller 103 calculating a derived encryption key from the authentication information and decrypting a given encryption key stored on the memory 104 using the derived encryption key.

At step 406a, the controller 103 provides information to the encryption module 106, 106a, 106b indicating that the new encryption algorithm should be used to encrypt or decrypt data.

Then, as before, at step 408, the device 100, 100a, 100b is ready to encrypt data using the chosen encryption algorithm.

Again, in embodiments having a display 102, the controller 103 may indicate which encryption algorithm has been determined for use, either before or immediately after steps 502 and 504. This may, for example, be an indication of the last-used encryption algorithm or an indication of a default algorithm.

1. A portable encryption device comprising:
a controller having a plurality of modes;
an encryption engine connected to or implemented within the controller; an internal memory for storing a plurality of encryption keys;
a battery;
an input device connected to the controller and for selecting between the plurality of modes; and
a connector for connecting the portable encryption device to a computer; wherein the battery is arranged to selectively provide electrical power to the controller and input device such that the plurality of modes are user-selectable while the device is not connected to a computer;
wherein, in a first mode of the plurality of modes, the encryption engine is configured to encrypt and decrypt data using a first encryption algorithm; and
wherein, in a second mode of the plurality of modes, the encryption engine is configured to encrypt and decrypt data using a second encryption algorithm, different from the first encryption algorithm.

2. The portable encryption device of claim 1, wherein the plurality of modes comprises a third mode, wherein in the third mode, the controller is configured to encrypt and decrypt data using a third encryption algorithm, different from each of the first and second algorithms.

3. The portable encryption device of claim 1, wherein each encryption algorithm is an algorithm selected from a group comprising: AES, DES, RSA, ECC, ECB, CBC, CTR, CFB, XTS, and GCM encryption algorithms, and their respective algorithm modes.

4. The portable encryption device of claim 1, wherein a plurality of encryption keys are stored on the internal memory, wherein each encryption key is associated with at least one of the modes.

5. The portable encryption device of claim 4, wherein at least one encryption key is associated with at least two modes out of the plurality of modes.

6. The portable encryption device of claim 1, further comprising a second connector for connecting to an external storage device, wherein the portable encryption device is configured to encrypt data received via the connector, based on the selected mode, and wherein the device is configured to pass the encrypted data to the second connector.

7. The portable encryption device of claim 1, further comprising a second internal memory, wherein the portable encryption device is configured to encrypt data received via the connector, based on the selected mode, and wherein the device is configured to store the encrypted data on the second internal memory.

8. The portable encryption device of claim 1, wherein the controller is configured to receive authentication information via the input device and to calculate a derived encryption key from the received authentication information; and to decrypt at least one encryption key stored on the internal memory using the derived encryption key and to provide the decrypted encryption key to the encryption engine.

9. The portable memory storage device of claim 1, wherein the input device comprises a keypad, a button, or a touchscreen.

10. A system comprising a computer and the portable encryption device of claim 1, wherein the connector of the portable memory storage device is connected to the computer.

11. The system of claim 10, further comprising an external storage device, wherein the portable encryption device is connected to the external storage device.

12. A method of encrypting data using the portable encryption device of claim 1, the method comprising:
selecting, by a user, one mode out of the plurality of modes;
receiving, at the portable encryption device, data from a computer or from an external storage device; and encrypting the received data based on the selected mode.

13. The method of claim 12, comprising a step of either storing the encrypted data in the portable encryption device; or passing the encrypted data to one of a computer and an external storage device for storage.

14. The method of claim 12, further comprising the steps of:
receiving authentication information via the input device;
the controller calculating a derived encryption key from the received authentication information; and
the controller decrypting at least one encryption key stored on the internal memory using the derived encryption key and providing the decrypted encryption key to the encryption engine.
